(19) United States
(12) Patent Application Publication
(10) Pub. No.: US 2021/0039884 A1
(43) Pub. Date: Feb. 11, 2021

(54) METHOD AND APPARATUS FOR OPERATING AN AUTOMATIC STORAGE SYSTEM

(71) Applicant: SAMSUNG ELECTRONICS CO., LTD., Suwon-si (KR)

(72) Inventors: Tarik Tosun, Brooklyn, NY (US); Daewon Lee, Princeton, NJ (US); Galen Xing, Bronx, NY (US); Zixuan Lan, Philadelphia, PA (US); Lawrence Jackel, Holmdel, NJ (US); Sebastian Seung, Princeton, NJ (US); Daniel Lee, Tenafly, NJ (US)

(73) Assignee: SAMSUNG ELECTRONICS CO., LTD., Suwon-si (KR)

(21) Appl. No.: 16/707,674

(22) Filed: Dec. 9, 2019

Related U.S. Application Data
(60) Provisional application No. 62/885,037, filed on Aug. 9, 2019.

(51) Int. Cl. B65G 1/137; G06N 3/08; G06F 16/51; G06F 16/538; G06N 3/04; G06F 16/242; G06Q 10/08

(52) U.S. Cl. CPC B65G 1/1373; G06N 3/08; G06F 16/51; G06Q 10/087; G06N 3/04; G06F 16/243; G06F 16/538

(57) ABSTRACT

An apparatus for controlling a storage system may include: a memory, and a processor configured to: identify a storage command for storing a physical object in the storage system and a description of the physical object; when the physical object is placed in the storage system, store, in the memory, the description of the physical object in association with a storage location in the storage system at which the physical object is placed; identify a retrieval command for retrieving the physical object from the storage system, and perform the retrieval command based on the description and the storage location of the physical object.

### CROSS-REFERENCE TO RELATED APPLICATION

This application claims priority under 35 U.S.C. § 119 from U.S. Provisional Application No. 62/885,037 filed on Aug. 9, 2019 in the U.S. Patent & Trademark Office, the disclosure of which is incorporated herein by reference in its entirety.

### FIELD

Methods and apparatuses consistent with embodiments relate to operating an automatic storage system, and more particular, operating an automatic storage system capable of automatically storing and retrieving physical objects according to user commands.

### BACKGROUND

Modern technology has revolutionized the way a computer system stores, organizes, and searches for information and data. In warehouses, there are attempts to automate the storage, organization, and retrieval of physical objects similarly to the manner in which data and information are stored and searched by a computer system.

For example, robots are utilized in warehouse fulfillment centers to track and fetch products to reduce labor cost and improve efficiency. However, such robotic automation needs a highly structured environment in which radio frequency identification (RFID) tags and barcodes are used to label every box and palette. In addition, stored objects and storage shelves may have to be labeled by humans to set up the structured environment as a prerequisite for the robotic automation.

Therefore, there is a need for developing an automatic storage system that may not require physical markers, labels, or tags to track the objects for various unstructured storage environments, including warehouses, retail stores, and homes.

### SUMMARY

According to an aspect of the disclosure, an apparatus for controlling a storage system may include: an input interface configured to receive a first user input and a second user input; at least one memory configured to store program code; at least one processor configured to execute the program code to: identify, from the first user input, a storage command for storing a physical object in the storage system and a first description of the physical object; when the physical object is placed at a storage location in the storage system, store, in the at least one memory, the first description of the physical object in association with information of the storage location; identify, from the second user input, a retrieval command for retrieving the physical object from the storage system and a second description of the physical object; and perform the retrieval command based on the storage location of the physical object, in response to the second description of the physical object corresponding to the first description of the physical object.

The at least one processor may be further configured to execute the program code to: extract information of a user identification from the first user input and store the user identification in the at least one memory; store the first description of the physical object in association with the storage location of the physical object and the user identification; and perform the retrieval command in response to the second description of the physical object corresponding to the first description of the physical object and the second user input being verified as generated by a user that matches the user identification.

The at least one memory may be configured to store a plurality of storage location identifications (ID) that are assigned to a plurality of storage locations in the storage system, and wherein the at least one processor may be s further configured to execute the program code to: in response to the storage command, assign one of the plurality of storage location IDs to the physical object as the storage location of the physical object.

The at least one processor may be further configured to execute the program code to: in response to the retrieval command, control a motor of the storage system to move a storage part of the storage system having the assigned storage location ID to a retrieval position of the storage system.

The storage part of the storage system may be a shelf, a drawer, or a compartment of the storage system having the assigned storage ID, and the retrieval position of the storage may be a door, a hole, or an opening of the storage system.

The at least one processor may be further configured to execute the program code to: control a camera to capture an image of the physical object when the physical object is placed in the storage system; control the least one memory to store the image of the physical object in association with the first description of the object; and control a display to display the image of the physical object in response to the retrieval command.

The at least one processor may be further configured to execute the program code to: control a sensor to detect a storage time at which the physical object is placed in the storage system; and control the least one memory to store the storage time in association with the first description of the physical object.

The at least one processor may be further configured to execute the program code to: perform the retrieval command in response to the second description of the physical object corresponding to the first description of the physical object, and a storage time included in the second user input matching the storage time of the physical object.

The input interface may include a microphone configured to receive a first voice signal and a second voice signal as the first user input and the second user input. The at least one processor may be further configured to execute the program code to: perform a speaker verification process on the first voice signal and the second voice signal using a neural network to extract voice characteristics of a user; and perform the retrieval command in response to the voice characteristics in the second voice signal corresponding to the voice characteristics in the first voice signal.

The at least one processor may be further configured to execute the program code to: perform the retrieval command by providing visual or audible information of the storage location of the physical object to a user.

The at least one processor may be further configured to execute the program code to: control a display to display the storage location of the physical object in a layout image of the storage system, in response to the retrieval command.

The at least one processor may be further configured to execute the program code to: control a visual indicator positioned at the storage location of the physical object to cause the visual indicator to change a color, blink, or flash, in response to the retrieval command.

The at least one processor may be further configured to execute the program code to: control a door of the storage system to be opened in response to the storage command; and control the door to be closed in response to determining that the physical object is placed in the storage system, or in response to a preset time being elapsed.

The at least one memory may be configured to: store an object list comprising a plurality of different object descriptions associated with corresponding storage times and object images. The at least one processor may be further configured to execute the program code to: provide the object list in response to the second description of the physical object not corresponding to the first description of the physical object.

According to an aspect of the disclosure, a method for controlling a storage system may include: receiving a first user input; identifying, from the first user input, a storage command for storing a physical object in the storage system and a first description of the physical object; when the physical object is placed at a storage location in the storage system, storing, in at least one memory, the first description of the physical object in association with the storage location; receiving a second user input; identifying, from the second user input, a retrieval command for retrieving the physical object from the storage system and a second description of the physical object, and performing the retrieval command based on the storage location of the physical object, in response to the second description of the physical object corresponding to the first description of the physical object.

The method may further include: extracting information of a user identification from the first user input and storing the user identification in the at least one memory; store the first description of the physical object in association with the storage location of the physical object and the user identification; and performing the retrieval command in response to the second description of the physical object corresponding to the first description of the physical object and the second user input being verified as generated by a user that matches the user identification.

The method may further include: storing a plurality of storage location identifications (ID) that are assigned to a plurality of storage locations in the storage system; and in response to identifying the storage command, assigning one of the plurality of storage location IDs to the physical object as the storage location at which the physical object is to be placed.

The method may further include: capturing an image of the physical object when the physical object is placed in the storage system; storing the image of the physical object in association with the first description of the object; and displaying the image of the physical object in response to the retrieval command.

The method may further include: detecting a storage time at which the physical object is placed in the storage system; and storing the storage time in association with the first description of the physical object.

The performing the retrieval command may include: performing the retrieval command in response to the second description of the physical object corresponding to the first description of the physical object, and a storage time included in the second user input matching the storage time of the physical object.

The first user input and the second user input may correspond to a first voice signal and a second voice signal, respectively. The performing the retrieval command may include: performing a speaker verification process on the first voice signal and the second voice signal using a neural network to extract voice characteristics of a user; and performing the retrieval command in response to the voice characteristics in the second user input corresponding to the voice characteristics in the first user input.

The performing the retrieval command may include: performing the retrieval command by providing visual or audible information of the storage location of the physical object to the user.

The performing the retrieval command may further include: displaying the storage location of the physical object in a layout image of the storage system, in response to the retrieval command.

The performing the retrieval command may further include: controlling a visual indicator positioned at the storage location of the physical object to cause the visual indicator to change a color, blink, or flash, in response to the retrieval command.

The method may further include: in response to the second description of the physical object not corresponding to the first description of the physical object, providing an object list including a plurality of different object descriptions associated with corresponding storage times and object images.

While the afore described methods, devices, and non-transitory computer-readable mediums have been described individually, these descriptions are not intended to suggest any limitation as to the scope of use or functionality thereof. Indeed these methods, devices, and non-transitory computer-readable mediums may be combined in other aspects of the disclosure.

### BRIEF DESCRIPTION OF THE DRAWINGS

The above and other aspects, features, and aspects of embodiments of the disclosure will be more apparent from the following description taken in conjunction with the accompanying drawings, in which:

FIG. 1 illustrates a storage system in accordance with embodiments;

FIG. 2 illustrates a method of recognizing an object requested to store or retrieve by a user input, in accordance with embodiments;

FIG. 3 is a diagram describing a method of controlling a storage system to store a physical object in the storage system in accordance with embodiments;

FIG. 4 is a diagram describing a method of controlling a storage system to store a physical object in the storage system using a door operating system and a shelf moving system in accordance with embodiments;

FIG. 5 is a diagram describing a method of controlling a storage system to retrieve a physical object from the storage system in accordance with embodiments;

FIG. 6 is a block diagram of a configuration of a storage system in accordance with embodiments;

FIG. 7 illustrates a storage system in accordance with embodiments;

FIG. 8 is a block diagram of a configuration of a storage system in accordance with embodiments;

FIG. 9 is a flowchart of a process of controlling a storage system to store a physical object in the storage system in accordance with embodiments; and

FIGS. 10 and 11 illustrate a flowchart of controlling a storage system to retrieve a physical object from the storage system in accordance with embodiments.

### DETAILED DESCRIPTION

Embodiments of the present disclosure provide an automatic storage system and an operating method thereof, in which a user may store or retrieve a physical object in or from the automatic storage system through a conversation with the automatic storage system.

As the disclosure allows for various changes and numerous examples, the embodiments will be illustrated in the drawings and described in detail in the written description. However, this is not intended to limit the disclosure to modes of practice, and it will be understood that all changes, equivalents, and substitutes that do not depart from the spirit and technical scope of the disclosure are encompassed in the disclosure.

In the description of the embodiments, detailed explanations of related art are omitted when it is deemed that they may unnecessarily obscure the essence of the disclosure. Also, numbers (for example, a first, a second, and the like) used in the description of the specification are identifier codes for distinguishing one element from another.

Also, in the present specification, it will be understood that when elements are “connected” or “coupled” to each other, the elements may be directly connected or coupled to each other, but may alternatively be connected or coupled to each other with an intervening element therebetween, unless specified otherwise.

In the present specification, regarding an element represented as a “unit,” a “module,” or an “operating system,” two or more elements may be combined into one element or one element may be divided into two or more elements according to subdivided functions. In addition, each element described hereinafter may additionally perform some or all of functions performed by another element, in addition to main functions of itself, and some of the main functions of each element may be performed entirely by another component.

An “input signal,” or a “user input” may include a voice signal, a text signal, and/or an image signal which is detected by a microphone, an input interface as such a keyboard or a touch screen, or a camera.

Also, in the present specification, an “image” may denote a still image, a moving image including a plurality of consecutive still images (or frames), or a video.

Also, in the present specification, a neural network is a representative example of an artificial intelligence model, but embodiments are not limited to an artificial intelligence model using an algorithm.

Also, in the present specification, a “parameter” is a value used in an operation process of each layer forming a neural network, and for example, may include a weight used when an input value is applied to an operation expression. Here, the parameter may be expressed in a matrix form. The parameter is a value set as a result of training, and may be updated through separate training data when necessary.

Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples.

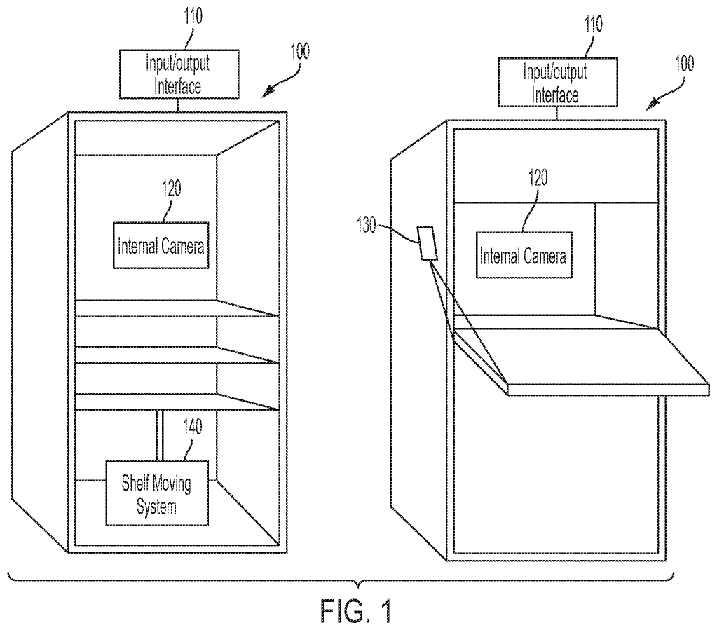

FIG. 1 illustrates a storage system 100 in accordance with embodiments.

As shown in FIG. 1, the storage system 100 may include an input/output interface 110, an internal camera 120, a door operating system 130, and a shelf moving system 140 to store and retrieve a physical object according to a user command.

The input/output interface 110 may be implemented as a microphone, a web camera including a microphone, and/or a touch screen to receive a user command. The microphone may receive a voice signal including a user command for storing an object (hereinafter, also referred to as “storage command”) and a description of the object (hereinafter, also referred to as ‘object description’ or ‘object description information’). For example, when the microphone detects an utterance “store my watch,” the word “store” may be recognized as the user command, and “watch” may be recognized as the description of the object to be stored. Also, the microphone may receive a voice signal including a user command for retrieving an object (hereinafter, also referred to as “retrieval command”) and a description of the object. For example, when the microphone detects an utterance “find my watch,” the word “find” may be recognized as the user command, and “watch” may be recognized as the description of the object to be retrieved.

The internal camera 120 may be positioned inside the storage system 100 to capture an image of the object when the object is placed in the storage system 100.

The door operating system 130 may control a door of the storage system 100 to be opened when the input/output interface 110 receives a storage command, and may control the door to be closed when it is determined that an object is placed in the storage system 100. The door operating system 130 may control the door of the storage system 100 to be opened when the input/output interface 110 receives a retrieval command, and may control the door to be closed when it is determined that an object is retrieved from the storage system 100. The door operating system 130 may include a motor, such as a servo motor or a stepper motor, to automatically open and close the door.

The shelf moving system 140 may control the movement of shelves using a motor to store and retrieve the object. For example, when the storage system 100 has a first shelf, a second shelf, and a third shelf having shelf ID 1, shelf ID 2, and shelf ID 3, respectively, and the shelf moving system 140 receives a storage command for storing an object on a shelf having shelf ID 2, the shelf moving system 140 lifts up or down the second shelf to locate the second shelf at the level of the door, so that the user can place the object on the second shelf when the door is opened. When the shelf moving system 140 receives a retrieval command for retrieving an object from a shelf having shelf ID 1, the shelf moving system 140 may move the first shelf up or down to place the first shelf at the door level so that the user can retrieve the object from the second shelf when the door is opened.

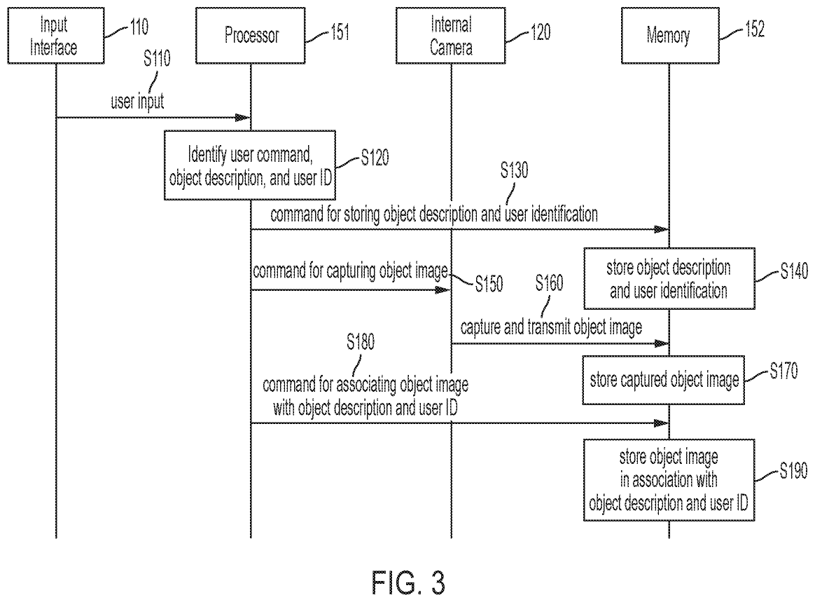

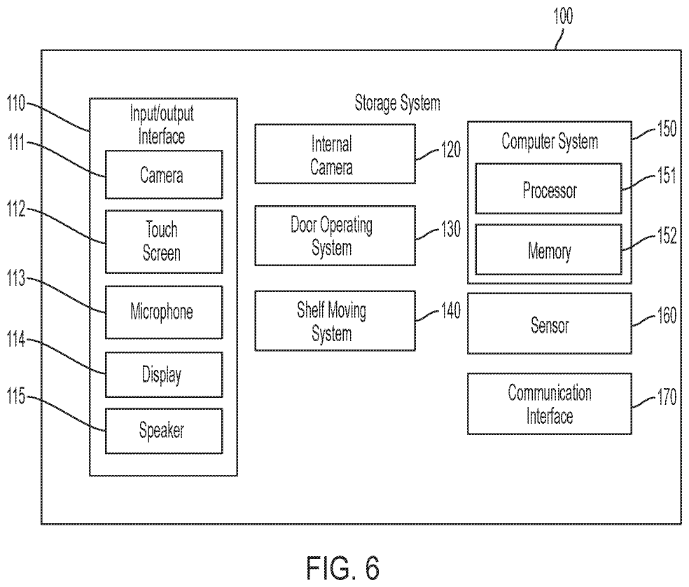

The storage system 100 may further include a computer system 150 (FIG. 6) including a processor 151 (FIG. 3) and a memory 152 (FIG. 3) to control the input/output interface 110, the internal camera 120, the door operating system 130, and the shelf moving system 140 although the processor 151 and the memory 152 are not illustrated in FIG. 1.

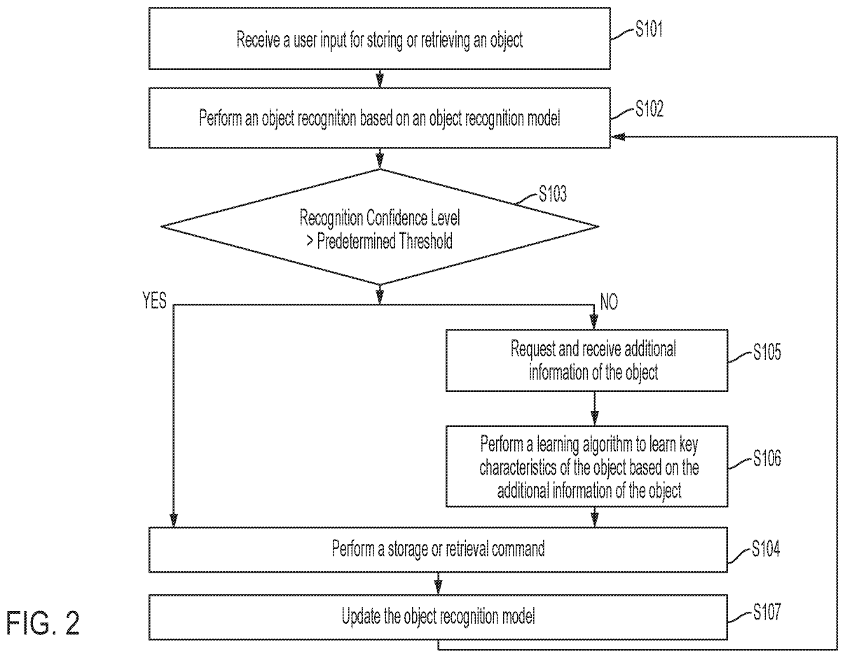

FIG. 2 illustrates a method of recognizing an object requested to store or retrieve by a user input, in accordance with embodiments.

In operation S101, the storage system 100 may receive a user input for storing or retrieving an object in the storage system 100 or from the storage system 100, via the input/output interface 110. For example, the user input may include a voice command or a touch input command that requests the storage system 100 to store or retrieve the object. Alternatively, the user input may be received from an external device (e.g., a smartphone) via wireless communication. The user input may include a name, an attribute, and/or a characteristic of the object. Also, the user input may include an image of the object. For example, when the user presents the object in front of the input/output interface 110, the storage system 100 may activate the camera of the input/output interface 110 and may capture the image of the object.

In operation S102, the storage system 100 may perform an object recognition based on information of the object included in the user input, by using an object recognition model. In particular, the storage system 100 may input at least one of the name, the attribute, the characteristic, and the image of the object to the object recognition model to identify the object which the user intends to store in or retrieve from the storage system 100. The object recognition model may be created based on at least one of an image-based object recognition algorithm, a text-based object recognition algorithm, and a voice-based object recognition algorithm, and the storage system 100 may identify the object and calculate a recognition confidence level of the result of identifying the object by using the object recognition model.

In operation S103, the storage system 100 may determine whether the recognition confidence level is greater than a predetermined threshold level.

If the storage system 100 determines that the recognition confidence level is greater than the predetermined threshold level, the storage system 100 may perform a storage or retrieval command according to the user input, in operation S104.

If the storage system 100 determines that the recognition confidence level is not greater than the predetermined threshold level, the storage system 100 may determine the object is an unknown object. In that case, the storage system 100 may request the user to provide additional information about the object, and may receive the additional information via the microphone, the camera, the touch screen of the input/output interface 110, in operation S105. For example, the additional information may include one or more additional images, names, attributes, and/or characteristics of the object.

In operation S106, the storage system 100 may perform a learning algorithm to learn key characteristics of the unknown object based on the additional information of the object, and the storage system 100 may proceed to operation S104 to perform the storage or retrieval command based on the learned key characteristics of the object.

After performing the storage or retrieval command in operation S104, the storage system 100 may update the object recognition model in operation S107, so that when a next user input for storing or retrieving an object is received, the storage system 100 may perform the object recognition based on the updated recognition model in operation S102.

FIG. 3 is a diagram describing a method of storing an object in a storage system in accordance with embodiments.

With reference to FIG. 3, operations of the input/output interface 110, the processor 151, the internal camera 120, and the memory 152 of the storage system 100 are described hereinafter.

The input/output interface 110 may receive a user input and transmit the user input to the processor 151, in operation S110. The input/output interface 110 may include a camera, a touch screen, a microphone, and/or a web camera including a microphone. The user input may include a storage command for storing a physical object in the storage system 100, a retrieval command for retrieving the physical object from the storage system 100, description of the physical object, and/or user identification information.

For example, the microphone may receive a voice signal that contains a voice command for storing the physical object, description of the physical object, and user identification information. Here, the user identification information may be also referred to as speaker recognition information, speaker verification information, or speaker authentication information. The camera may be provided to capture a facial image of the user and to provide information for verifying the user's identification through facial recognition.

In another example, the user input may be received through the touch screen by detecting a touch input made on the screen. The user may be allowed to select a user command from a plurality of user command options, type a user command on the touch screen, and/or enter a user name and a password as user identification information, The user may be allowed to store his/her fingerprint, as a user identification, using the touch screen or a fingerprint scanner.

The processor 151 may identify the user command, the description of the object, the user identification from the user input, in operation S120.

When the input/output interface 110 receives a sound signal as the user input, the processor 151 may execute a Voice Activity Detector (VAD) module stored in the memory 152 to determine if the sound signal contains a voice.

When the processor 151 determines that the sound signal contains a voice, the processor 151 may extract the voice from the sound signal and may feed the extracted voice into a speaker recognition pipeline to identify the user command, the object description, and the user identification.

For example, when the processor 151 detects a word, “store,” “keep,” or synonyms thereof from the voice, the processor 151 may recognize the user input as a storage command.

The processor 151 may recognize a noun or an object (sentence element) (e.g., watch) that follows a word (e.g., “store,” “keep,” etc.) for the storage command as the object description. A voice segment corresponding to the object description is not limited to a single word, but may include more than one word, a clause, a phrase, or a sentence. For example, when the user input is a voice signal saying “store my phone,” the processor 151 identifies the word ‘store’ as a storage command and ‘phone’ as the object description.

The processor 151 may perform speaker recognition on the sound signal based on a SincNet neural network architecture. The SincNet neural network architecture uses sinc functions and learns high and low cut off frequencies for the sinc functions. The processor 151 may process the voice to extract characteristics of the voice in the sound signal and store the extracted characteristics of the voice as the user identification.

The processor 151 may store acoustic patterns of the sound signal in the memory 152 as the user identification.

The processor 151 may perform the user authentication via fingerprint recognition instead of or in combination with the speaker recognition. The processor 151 may collect a fingerprint of the user from the touch screen or a fingerprint scanner and store the user's fingerprint as the user identification.

The processor 151 may generate a command for storing the object description in association with the user identification, and may transmit the command to the memory 152, in operation S130. According to the command from the processor 151, the memory 152 may store the object description in association with the user identification in the memory 152, in operation S140.

The processor 151 may generate an image capture command for capturing an image of the object and may transmit the image capture command to the internal camera 120, in operation S150. Operation S150 may be performed before or after operation S130, or in parallel with operation S130.

The internal camera 120 may capture the object image when the object is placed inside the storage system 100. The internal camera 120 may transmit the object image to the memory 152, in operation S160.

The memory 152 may store the captured object image in the memory 152 in operation S170.

The processor 151 may generate and send a command for associating the object image with the object description and the user identification, in operation S180.

The memory 152 may store the object image in association with the object description and the user identification, in operation S190. For example, the memory 152 may store the following mapping table:

TABLE 1

| | Object | | User |
|---|---|---|---|
| | Description | Object Image | Identification |
| Object 1 | Watch | Image of Watch | User ID 1 |
| Object 2 | Phone | Image of Phone | User ID 2 |
| Object 3 | Key | Image of Key | User ID 3 |

In embodiments of the disclosure, the processor 151 may detect a time at which the user input 110 is received, and/or detect a time at which the object image is captured by the internal camera 120, as a storage time at which the object is placed in the storage system 100. The processor 151 may control the memory 152 to store the object description and the object image in association with the storage time, so that the user can later retrieve the object based on the storage time as well as the object description and the object image. In this case, the memory 152 may store the following mapping table:

TABLE 2

| | Object | | | |
|---|---|---|---|---|
| | Description | Object Image | User ID | Storage Time |
| Object 1 | Watch | Image of Watch | User ID 1 | Storage Time 1 |
| Object 2 | Phone | Image of Phone | User ID 2 | Storage Time 2 |
| Object 3 | Key | Image of Key | User ID 3 | Storage Time 3 |

Referring back to operation S150, the processor 151 may generate the image capturing command after a preset time elapses since the user input is received from the input/output interface 100 in operation S110, under the assumption that the user may have placed the object in the storage system 100 within the preset time after giving the storage command.

In another example, the storage system 100 may include a sensor to detect that an object is placed in the storage system 100, and the processor 151 may generate the image capturing command in operation S150 when the sensor provides an object detection signal to the processor 151.

Examples of the sensor include a presence detection sensor and a weight detection sensor. The presence detection senor may include a light emitter configured to emit a light to shelves, drawers, and/or compartments of the storage system 100 where the object is to be placed, and a light detector configured to detect the light backscattered from the shelves, drawers, and/or compartments. When a pattern of light detected by the light detector is changed by more than a light pattern change threshold, the presence detection sensor may determine that a new object is placed in the storage system 100. The weight detection sensor may be attached to or coupled to the shelves, drawers, and/or compartments of the storage system 100, and may detect a change in the weight of the shelves, drawers, and/or compartments. The weight detection sensor may determine that a new object is placed in the storage system 100 when the change in the weight is greater than a weight change threshold. In another embodiment, the determining process of the present detection sensor and the weight sensor may be performed by the processor 151.

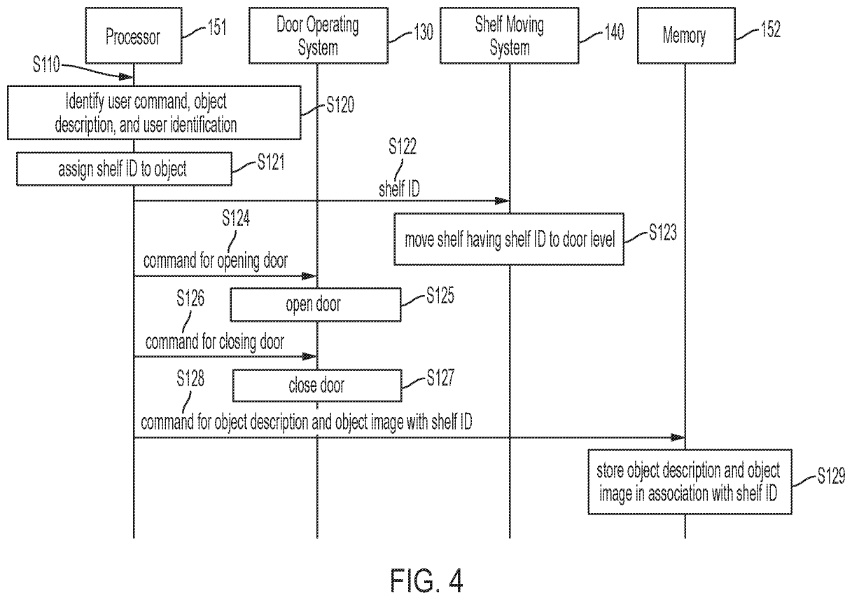

FIG. 4 is a diagram describing a method of storing an object using a door operating system 130 and a shelf moving system 140 in accordance with embodiments. In embodiments of the present disclosure, the processor 151 may be configured to assign a location (e.g., a particular shelves, drawers, or compartments) of the storage system 100 to an object to be placed into the storage system 100.

As shown in FIG. 4, operation S121 through operation S129 may occur between operation S120 and operation S130 illustrated in FIG. 3, but the operation times are not limited thereto.

When the processor 151 identifies a user command, an object description, and a user identification from a user input in operation S120, the processor 151 may assign a shelf ID to the object in operation S121, so that the object is to be stored on a shelf having the assigned shelf ID, among a plurality of shelves in the storage system 100. In a case in which the storage system 100 includes one or more compartments and/or drawers, the terms “compartment ID” and “drawer ID” may be used in addition to the “shelf ID.” Alternative to or in combination with the terms “shelf ID,” “compartment ID” and “drawer ID”, the term “storage location ID” may be used. Here, the term ‘shelf ID’ and ‘compartment ID’ may be also referred to as ‘storage location ID.’ For convenience of description, the term “shelf ID” is used with reference to FIG. 4.

The processor 151 may transmit the shelf ID to the shelf moving system 140 in operation S122, and the shelf moving system 140 may lift up or down the shelf having the assigned shelf ID to the door level in operation S123, so that when the door is open, the user can place the object on the shelf having the shelf ID.

In embodiments of the present disclosure, the storage system 100 may not have a door, and instead may have a hole through which the user can drop or place a physical object into the storage system 100. In that case, the processor 151 may control the shelf moving system 140 to bring the shelf having the assigned shelf ID to the position of the hole, so that when the user inserts the object into the hole, the object can be placed on the shelf having the shelf ID.

When the shelf having the assigned shelf ID is placed at the door level, the processor 151 may generate a door opening command for opening the door and transmit the door opening command to the door operating system 130, in operation S124. The shelf moving system 140 may send a shelf movement completion signal to the processor 110 when operation S123 is done, so that the process 110 determines the time to generate the command for opening the door in operation S124.

The door operating system 130 opens the door according to the door opening command. According to a user input or a detection signal from the sensor indicating that the object is placed in the storage system 100, the processor 151 may generate a door closing command for closing the door in operation S126. Upon receiving the door closing command, the door operating system 130 may drive a motor to closes the door, in operation S127.

In embodiments of the present disclosure, operations S124-S127 and the door operating system 130 may be omitted, and the door may be manually opened or closed by the user. In that case, the processor 151 may control a display, a light-emitting diode (LED), or a speaker to inform the user of the time at which the user is allowed to open the door to place the object in the storage system 100. For example, a message saying “open the door” may be provided visually or audibly using the display or the speaker. The LED may be turned on to display a particular color, or may flash or blank to indicate that it is a time to open the door.

In operation S128, the processor 151 may generate and transmit a command for storing the object description in association with the shelf ID, to the memory 152.

In operation S129, the memory 152 may store the object description and the user identification in connection with the shelf ID, in the memory 152. For example, the memory 152 may store the following mapping table:

TABLE 3

| | Object | | | |
|---|---|---|---|---|
| | Description | Object Image | User ID | Shelf ID |
| Object 1 | Watch | Image of Watch | User ID 1 | Shelf ID 1 |
| Object 2 | Phone | Image of Phone | User ID 2 | Shelf ID 2 |
| Object 3 | Key | Image of Key | User ID 3 | Shelf ID 3 |

Storage times (e.g., year, month, date and/or time) at which the objects are placed in the storage system 100 may be added to the mapping table as shown below:

TABLE 4

| | Object | | | | |
|---|---|---|---|---|---|
| | Description | Object Image | User ID | Shelf ID | Storage Time |
| Object 1 | Watch | Image of Watch | User ID 1 | Shelf ID 1 | Storage Time 1 |
| Object 2 | Phone | Image of Phone | User ID 2 | Shelf ID 2 | Storage Time 2 |
| Object 3 | Key | Image of Key | User ID 3 | Shelf ID 3 | Storage Time 3 |

The processor 151 may keep track of an elapsed time since each of the objects is placed in the storage system 100 (e.g., an elapsed time since Storage Time 1, Storage Time 2, and Storage Time 3, in [Table 4]), and may control the input/output interface 110 to suggest to the users retrieving the objects when the elapsed time exceeds a threshold storage time. For example, the processor 151 may control the input/output interface 110 to visually or audibly provide the user with information indicating that a banana has been stored in the storage system 100 for two weeks and to suggest that the user take out the banana from the storage system 100.

The processor 151 may analyze the number of objects stored in the storage system 100, and may provide information of the number of objects via the input/output interface 110.

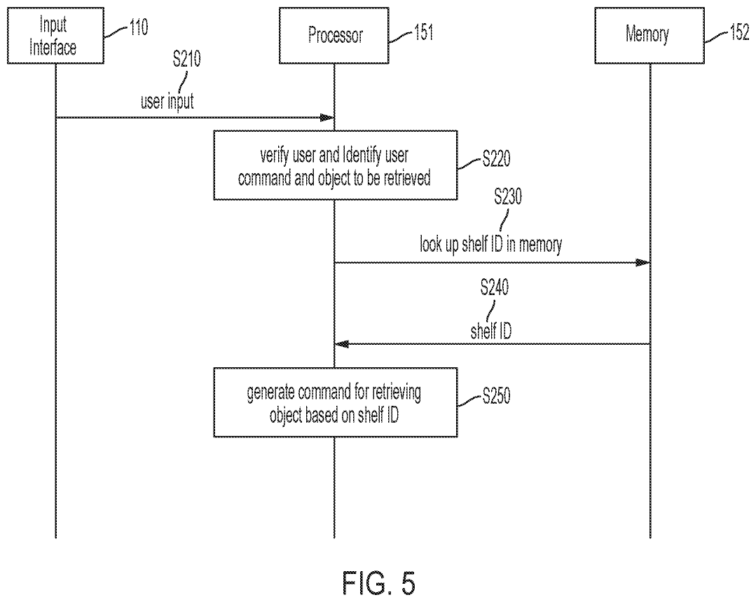

FIG. 5 is a diagram describing a method of retrieving a physical object from a storage system in accordance with embodiments.

With reference to FIG. 5, the input/output interface 110 may receive a user input including a retrieval command for retrieving an object, a description of the object, a user identification, and may transmit the user input to the processor 151, in operation S210.

In operation S220, the processor 151 may verify the user based on information of the user identification, and may identify the retrieval command and the object to be retrieved based on the object description.

When the storage system 100 stores a plurality of objects that belong to a plurality of different users, the processor 151 may control the storage system 100 to show or retrieve only the object(s) that belongs to the verified user. For example, with reference to [Table 3], if a first user is verified as having User ID 1, the storage system 100 may retrieve Object 1 to the first user according to the first user's retrieval command, and may not show an image or a list of objects that belong to other users (e.g., a second user having User ID 2 and a third user having User ID 3).

The processor 151 may not execute the retrieval command if the user is not verified, but the storage system 100 may be set to omit the user verification operation. Also, the processor 151 may not execute the retrieval command when the object description in the user input does not match an object description stored in the memory 152. When the processor 151 determines that at least one of a pre-stored object description and a user identification information that are stored in the memory 152 does not match the object description and the user identification in the user input received in operation S210, the processor 151 may not perform the retrieval command. Instead, the processor 151 may control the memory 152 to provide a list of object information. For example, the list of object information may include a plurality of different object descriptions associated with corresponding storage times and object images. The user may be allowed to select one object description from the list to retrieve the corresponding object from the storage system 100.

In operation S220, when the user input is received in the form of a sound signal, the processor 151 determines whether the sound signal contains a voice. For example, the processor 151 may execute a Voice Activity Detector (VAD) module stored in the memory 152 to determine if the sound signal contains a voice.

The processor 151 may extract the voice from the sound signal and may feed the extracted voice into a speaker recognition pipeline to identify the user command, the object description, and the user identification.

The processor 151 may perform speaker recognition on the sound signal based on a SincNet neural network architecture. The SincNet neural network architecture uses sinc functions and learns high and low cut off frequencies for the sinc functions.

The processor 151 may process the voice to authenticate or verify the identify the user based on characteristics of the voice. For example, the processor 151 may compare acoustic patterns of the received sound signal with pre-stored acoustic patterns of the user in the memory 152, and may authenticate the user when a degree of similarity between the acoustic patterns of the received sound signal and the pre-stored acoustic patterns is greater than a threshold value.

The processor 151 may perform the user authentication via fingerprint recognition instead of or in combination with the speaker recognition. The processor 151 may obtain a fingerprint from the touch screen or a fingerprint scanner and may verify the user by comparing the obtained fingerprint with a pre-stored fingerprint of the user.

The processor 151 may parse the sound signal to identify the user command and the object identification. For example, when the processor 151 detects a word, “retrieve,” “find,” “get,” or synonyms thereof from the voice, the processor 151 may recognize the user input as a retrieval command.

The processor 151 may recognize a noun or an object (sentence element) (e.g., watch) that follows a word (e.g., “retrieve”, “find,” etc.) for the retrieval command as the object description. A voice segment corresponding to the object description is not limited to a single word, but may include more than one word, a clause, a phrase, or a sentence. For example, when the user input contains an utterance “find my watch,” the processor 151 may identify the word “find” as a retrieval command for retrieving an object, and identify the word “watch” as a description of the object to be retrieved.

In operations S230 and S240, the processor 151 may look up a shelf ID corresponding to the object description, in the memory 152. For example, the processor 151 may refer to Table 3 or Table 4 in the memory 152 to find a shelf ID associated with the object description.

In operation S250, the processor 151 may generate a retrieval command for retrieving the object based on the shelf ID corresponding to the object description. In particular, the processor 151 may control the shelf moving system 140 to move the shelf having the shelf ID to the door level, and then may control the door opening system 130 to open the door so that the user can take out the object from the storage system 100. In another example, the processor 151 may control a display to provide the user with the shelf ID so that the use can retrieve the object from the shelf having the shelf ID. In example embodiments, a compartment ID, a drawer ID, or a storage location ID may be provided instead of the shelf ID.

FIG. 6 is a block diagram of a configuration of a storage system in accordance with embodiments.

As shown in FIG. 6, a storage system 100 according to embodiments may include an input/output interface 110, an internal camera 120, a door operating system 130, a shelf moving system 140, a computer system 150, a sensor 160, and a communication interface 170.

The input/output interface 110 may include a camera 111, a touch screen 112, a microphone 113, a display 114, and a speaker 115.

The display 114 may display various image data and a user interface (UI). The display 114 may display a real-time image of the object, a still image of the object captured at the time when the object was stored, and/or a location whether the object is stored. Information of the object location may be provided as a storage location ID (e.g., a shelf ID, a drawer ID, or compartment ID), or by displaying the location in a layout image of the storage system 100.

The speaker 115 may include various audio output circuitry and is configured to output various kinds of alarm sounds or voice messages. The speaker 115 may provide information of the object location via a voice message.

The input/output interface 110 may be disposed an external surface of the storage system 100 to receive a user input, such a user's voice signal detected by the microphone 113 or a touch input made on the touch screen 112, and/or capture an image of the user using the camera 111 while the user is present in front of the storage system 100 to store or retrieve a physical object.

The camera 111 may capture an image of the user to allow the storage system 100 to verify the user via facial recognition.

The touch screen 112 may be provided to receive a user's touch input including user identification (e.g., a user name and a password), a storage or retrieval command, and a description of an object to be stored in or retrieved from the storage system 100.

The microphone 113 may detect a voice signal that contains speaker verification information, a storage or retrieval command, and a description of an object to be stored in or retrieved from the storage system 100.

The internal camera 120 may be disposed inside the storage system 100 to capture an image of an object when the object is placed in the storage system 100. The internal camera 120 may transmit the captured image to the memory 152 under the control of the processor 151.

The door operating system 130 may include a motor to automatically open or close the door of the storage system 100, according to a door opening command or a door closing command from the processor 151.

The shelf moving system 140 may move a plurality of shelves together or individually to place an assigned shelf at a position of the door, so that the user can place an object on the shelf or take out the object from the shelf when the door is opened. In a case in which the door operating system 130 does not include a door, but provide a hole or an opening through which the user can insert or take out the object, the shelf moving system 140 may move the assigned shelf to the location of the hole or the opening. In a case in which the storage system 100 includes drawers and/or compartments, the shelf moving system 140 may move an assigned drawer or compartment to the location of the door, hole, or opening of the storage system 100.

The computer system 150 may include a processor 151 and a memory 152.

The processor 151 is implemented in hardware, firmware, or a combination of hardware and software. The processor may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, the processor 151 includes one or more processors capable of being programmed to perform a function. The processor may access the memory 152 and execute computer readable program instructions that are stored in the memory 152.

The processor 151 may control the input/output interface 110, the internal camera 120, the door operating system 130, the shelf moving system 140, the sensor 160, and the communication interface 170 to perform the operations described in FIGS. 2-5.

The memory 152 memory stores information, data, an operating system, a plurality of program modules software related to the operation and use of the motion estimating system. For example, the memory may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. For example, the memory 152 may include program instructions and codes configured to be executed by the processor 151 to perform operations S120, S121, S122, S124, S126, S128, S130, S150, S180, S220, S230, and S250.

The sensor 160 may a presence detection sensor and a weight detection sensor. The presence detection sensor may include a light emitter configured to emit a light to shelves, drawers, and/or compartments of the storage system 100 where the object is to be placed, and a light detector configured to detect the light backscattered from the shelves, drawers, and/or compartments. When a pattern of light detected by the light detector is changed by more than a light pattern change threshold, the presence detection sensor may determine that a new object is placed in the storage system 100. The weight detection sensor may be attached to or coupled to the shelves, drawers, and/or compartments of the storage system 100, and may detect a change in the weight of the shelves, drawers, and/or compartments. The weight detection sensor may determine that a new object is placed in the storage system 100 when the change in the weight is greater than a weight change threshold. In another embodiment, the determining process of the present detection sensor and the weight sensor may be performed by the processor 151. When the sensor 160 detects a new object, the sensor 160 may transmit an object detection signal to the processor 151 and/or the internal camera 120 so that the internal camera 120 captures an image of the object under the control of the processor 151, in response to the object detection signal.

The communication interface 170 may include a transceiver and/or a separate receiver and transmitter that enables the computer system 150 to communicate with other devices, such as via a wired connection, a wireless connection, or a combination of wired and wireless connections. The communication interface 170 may permit the computer system 150 to receive information from another device and/or provide information to another device. For example, the communication interface 170 may include an Ethernet interface, an optical interface, a coaxial interface, an infrared interface, a radio frequency (RF) interface, a universal serial bus (USB) interface, a Wi-Fi interface, a cellular network interface, or the like.

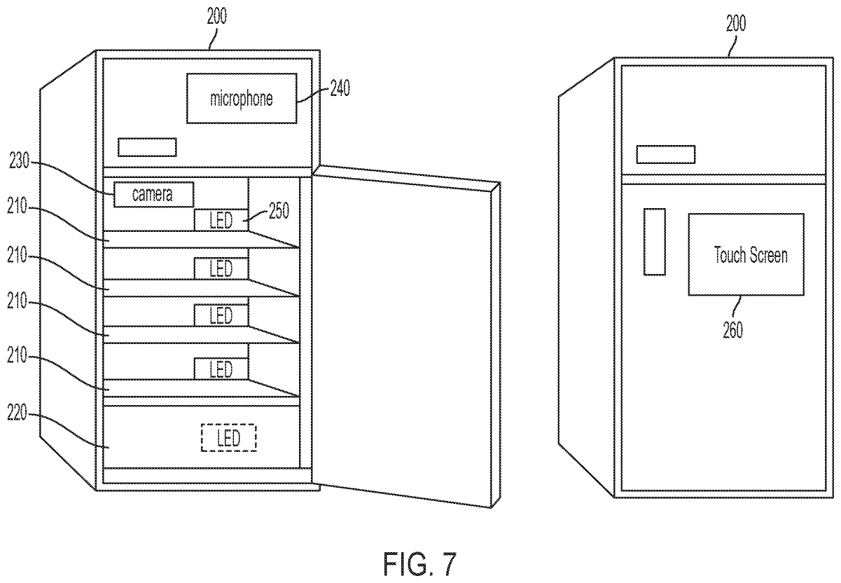

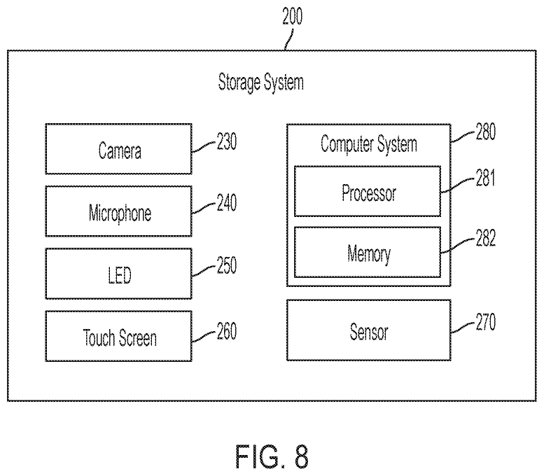

Examples of the storage system 100 may include various storage system including shelves, drawers, and compartments, and may be implemented as a refrigerator as shown in FIGS. 7 and 8.

As shown in FIG. 7, a storage system 200 according to embodiments of the present disclosure may include a plurality of shelves 210, at least one drawer 220, a camera 230, a microphone 240, a plurality of visual indicators, such as light emitting diodes (LED) 250, and a touch screen 260. The drawer 220 may be segmented to one or more compartments.

The camera 230 may monitor objects stored in the storage system 200 and monitor the time when objects are placed in and retrieved from the storage system 200. The camera 230 may capture an object image when the object is placed in the storage system 200. Also, the camera 230 may provide a real time image of the inside of the storage system 200.

The microphone 240 may receive a user's voice input which may include a voice command and a description of an object to be stored or retrieved.

The LEDs 250 may be turned on, change their colors, flash, or blink to draw a user's attention to a location of the object.

The touch screen 260 may be attached on an external surface of the storage system 200. The touch screen 260 may receive a user's touch input and display a still image and a real-time image of the interior of the storage system 200 that are captured by the camera 230. Also, the touch screen 260 may display a layout image of the interior of the storage system 200, and may display a marker or a symbol at a location in the layout image, which corresponds to the physical location of the object in the storage system 200.

As shown in FIG. 8, the storage system 200 may further include a sensor 270 and computer system 280. The computer system 280 includes a processor 281 and a memory 282.

The sensor 270 may be a present detection sensor and a weight detection sensor. The detection senor may include a light emitter configured to emit a light to the shelves 210 and the drawer 220 of the storage system 200 where the object is to be placed, and a light detector configured to detect the light backscattered from the shelves 210 and the drawer 220. When a pattern of light detected by the light detector is changed by more than a threshold amount, the detection sensor may determine that a new object is placed in the storage system 200. The weight detection sensor is attached to or coupled to each of the shelves 210 and the drawer 220, and determines that an object is placed in or retrieved from the storage system 200 when the weight of the shelves 210 and the drawer 220 changes by more than a threshold amount.

The processor 281 may control overall operations of the storage system 200. Specifically, when the microphone 240 may receive a user's voice input including an utterance “store this onion,” the processor 281 may identify the word “store” as a storage command for storing an object, and the word “onion” as a description of the object. The memory 282 may store a list of words corresponding to the storage command, and the processor 281 may determine whether the word “store” or a synonym of the word “store” is included in the list, to determine whether the user input contains the storage command. When the processor 281 determines that a storage command is received, the processor 281 may control the camera 230 to capture an image of the object to be stored in the storage system 200.

When the object is placed in the storage system 200, the processor 281 may identify a storage location ID corresponding to the location where the object is placed in the storage system 200, among the plurality of shelves 210 and the at least one drawer 220, based on an image signal received from the camera 230 and/or an object detection signal received from the sensor 270.

The processor 281 may control the memory 282 to store the storage location ID (e.g., a first shelf, or shelf ID 1) in association with the object description (e.g., “onion”), and may provide the user with location information corresponding to the storage location ID when a retrieval command is received.

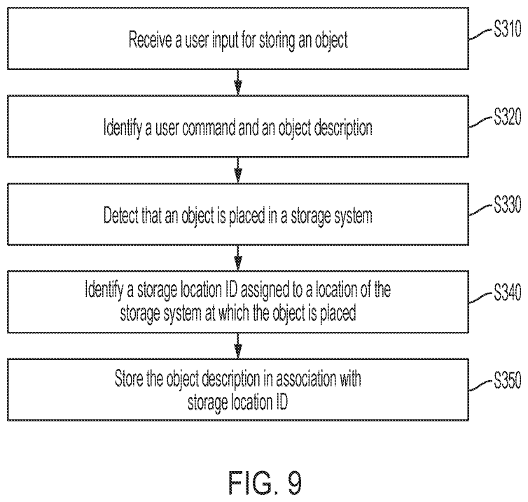

FIG. 9 is a flowchart of a process for storing a physical object in a storage system in accordance with embodiments.

As shown in FIG. 9, the microphone 240 or the touch screen 260 may receive a user input for storing a physical object in the storage system 200, in operation S310.

The processor 281 may identify a user command and an object description from the user input in operation S320.

The sensor 270 detects whether the object is placed in the storage system 240 in operation S330. Also, the sensor 270 may generate an object detection signal including information about a location of the object, such as a storage location ID assigned to the location where the object is placed, and may transmit the object detection signal to the processor 281. The processor 281 may identify the storage location ID from the object detection signal, in operation S340.

The processor 281 may control the memory 282 to store the object description (e.g., “onion”) in association with the storage location ID, in operation S350.

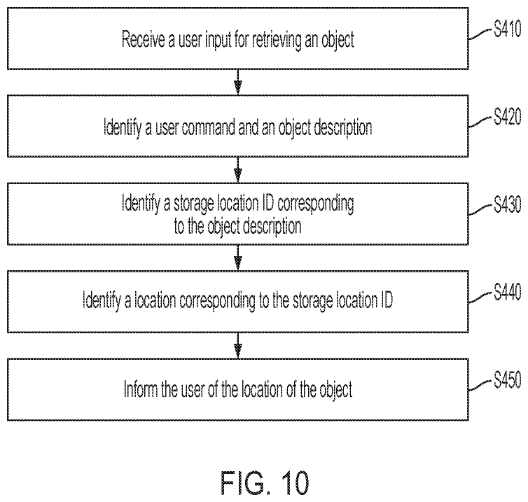

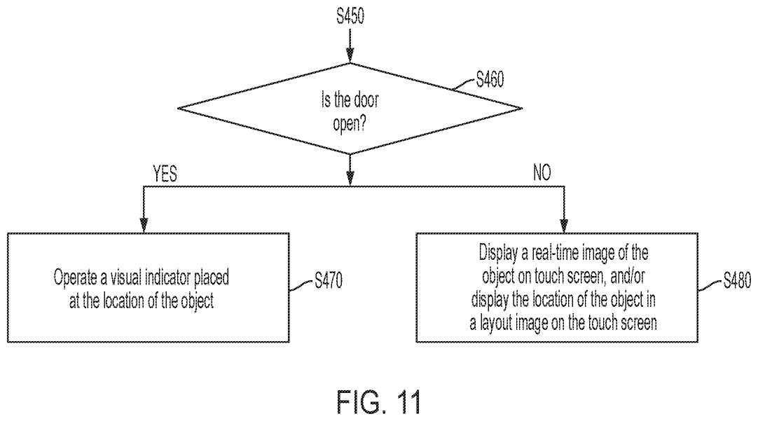

FIGS. 9 and 10 illustrate a flowchart of a process for retrieving a physical object from a storage system in accordance with embodiments.

With reference to FIGS. 9 and 10, the microphone 240 or the touch screen 260 may receive a user input for retrieving a physical object from the storage system 240, in operation S410.

The processor 281 may identify a user command and an object description from the user input in operation S420. For example, if the user input includes an utterance “find an onion,” the processor 281 may identify the user command as a retrieval command based on the word “find.” The memory 282 may store a list of words corresponding to the retrieval command, and the processor 281 may whether determine the word “find” or a synonym of the word “find” is included in the list, to determine whether the user input contains a retrieval command.

In operations S430 and S440, the processor 281 may identify a storage location ID corresponding to the object description from a plurality of storage location IDs stored in the memory 282, and identify a storage location corresponding to the storage location ID, among the plurality of shelves 210 and the at least one drawer 220.

In operation S450, the processor 281 may control the camera 230, the LED 250, and/or the touch screen 260, to inform the user of the location at which the object is placed.

In operation S460, the processor 281 may determine whether the door of the storage system 200 is open or closed.

If the sensor 270 detects that the door of the storage system 200 is open, the storage system 200 may control visual indictors located inside the storage system 200, such as the LEDs 250, to draw the user's attention to the location of the object, in operation S470. For example, the processor 281 controls the LEDs 250 so that an LED 250 placed at the location of the object is turned on among the plurality of LEDs 250 while the rest of the LEDs 250 are turned off. Also, the processor 281 may control the LEDs 250 so that the LED 250 placed at the location of the object displays a color different from the other LEDs 250. The processor 281 may enable the LED 250 placed at the location of the object to flash or blink while the other LEDs 250 stay turned on or turned off.

If the sensor 270 detects that the door of the storage system 200 is closed, the processor 281 may control the touch screen 260 to provide the storage location information, in operation S480. For example, the touch screen 260 may display a real-time image of the object, and/or display the location of the object in the layout image of the interior of the storage system 200, using a marker, an icon, or a symbol.

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed is:

1. An apparatus for controlling a storage system, the apparatus comprising:
an input interface configured to receive a first user input and a second user input;
at least one memory configured to store program code;
at least one processor configured to execute the program code to:
identify, from the first user input, a storage command for storing a physical object in the storage system and a first description of the physical object;
when the physical object is placed at a storage location in the storage system, store, in the at least one memory, the first description of the physical object in association with information of the storage location;
identify, from the second user input, a retrieval command for retrieving the physical object from the storage system and a second description of the physical object; and
perform the retrieval command based on the storage location of the physical object, in response to the second description of the physical object corresponding to the first description of the physical object.

2. The apparatus of claim 1, wherein the at least one processor is further configured to execute the program code to:
in response to identifying the physical object based on the first description of the physical object that comprises at least one of a name, an attribute, and an image of the physical object, perform the storage command; and
in response to failing to identify the physical object based on the first description, determining that the physical object is an unknown object, requesting additional information about the physical object, and performing a learning algorithm to learn characteristics of the physical object based on the additional information about the physical object.

3. The apparatus of claim 1, wherein the at least one processor is further configured to execute the program code to:
in response to identifying the physical object based on the second description of the physical object that comprises at least one of a name, an attribute, and an image of the physical object, perform the retrieval command; and
in response to failing to identify the physical object based on the second description, determining that the physical object is an unknown object, requesting additional information about the physical object, and performing a learning algorithm to learn characteristics of the physical object based on the additional information about the physical object.

4. The apparatus of claim 1, wherein the at least one processor is further configured to execute the program code to:
extract information of a user identification from the first user input and store the user identification in the at least one memory;
store the first description of the physical object in association with the storage location of the physical object and the user identification; and
perform the retrieval command in response to the second description of the physical object corresponding to the first description of the physical object and the second user input being verified as generated by a user that matches the user identification.

5. The apparatus of claim 1, wherein the at least one memory is configured to store a plurality of storage location identifications (ID) that are assigned to a plurality of storage locations in the storage system, and
wherein the at least one processor is further configured to execute the program code to:
in response to the storage command, assign one of the plurality of storage location IDs to the physical object as the storage location of the physical object.

6. The apparatus of claim 5, wherein the at least one processor is further configured to execute the program code to:
in response to the retrieval command, control a motor of the storage system to move a storage part of the storage system to a retrieval position of the storage system, and
wherein the storage part has the assigned storage location ID.

7. The apparatus of claim 6, wherein the storage part of the storage system is a shelf, a drawer, or a compartment of the storage system having the assigned storage ID, and the retrieval position of the storage is a door, a hole, or an opening of the storage system.

8. The apparatus of claim 1, wherein the at least one processor is further configured to execute the program code to:
control a camera to capture an image of the physical object when the physical object is placed in the storage system;
control the least one memory to store the image of the physical object in association with the first description of the object; and
control a display to display the image of the physical object in response to the retrieval command.

9. The apparatus of claim 1, wherein the at least one processor is further configured to execute the program code to:
control a sensor to detect a storage time at which the physical object is placed in the storage system; and
control the least one memory to store the storage time in association with the first description of the physical object.

10. The apparatus of claim 9, wherein the at least one processor is further configured to execute the program code to:
perform the retrieval command in response to the second description of the physical object corresponding to the first description of the physical object, and a storage time included in the second user input matching the storage time of the physical object.

11. The apparatus of claim 1, wherein the input interface comprises a microphone configured to receive a first voice signal and a second voice signal as the first user input and the second user input, and
wherein the at least one processor is further configured to execute the program code to:
perform a speaker verification process on the first voice signal and the second voice signal using a neural network to extract voice characteristics of a user; and
perform the retrieval command in response to the voice characteristics in the second voice signal corresponding to the voice characteristics in the first voice signal.

12. The apparatus of claim 1, wherein the at least one processor is further configured to execute the program code to:
perform the retrieval command by providing visual or audible information of the storage location of the physical object to a user.

13. The apparatus of claim 12, wherein the at least one processor is further configured to execute the program code to:
control a display to display the storage location of the physical object in a layout image of the storage system, in response to the retrieval command.

14. The apparatus of claim 12, wherein the at least one processor is further configured to execute the program code to:
control a visual indicator positioned at the storage location of the physical object to cause the visual indicator to change a color, blink, or flash, in response to the retrieval command.

15. The apparatus of claim 1, wherein the at least one processor is further configured to execute the program code to:
control a door of the storage system to be opened in response to the storage command; and
control the door to be closed in response to determining that the physical object is placed in the storage system, or in response to a preset time being elapsed.

16. The apparatus of claim 1, wherein the at least one memory is configured to: store an object list comprising a plurality of different object descriptions associated with corresponding storage times and object images; and
wherein the at least one processor is further configured to execute the program code to: provide the object list in response to the second description of the physical object not corresponding to the first description of the physical object.

17. A method for controlling a storage system, the method comprising:
receiving a first user input;
identifying, from the first user input, a storage command for storing a physical object in the storage system and a first description of the physical object;
when the physical object is placed at a storage location in the storage system, storing, in at least one memory, the first description of the physical object in association with the storage location;
receiving a second user input;
identifying, from the second user input, a retrieval command for retrieving the physical object from the storage system and a second description of the physical object, and
performing the retrieval command based on the storage location of the physical object, in response to the second description of the physical object corresponding to the first description of the physical object.

18. The method of claim 17, further comprising:
extracting information of a user identification from the first user input and storing the user identification in the at least one memory;
store the first description of the physical object in association with the storage location of the physical object and the user identification; and
performing the retrieval command in response to the second description of the physical object corresponding to the first description of the physical object and the second user input being verified as generated by a user that matches the user identification.

19. The method of claim 17, further comprising:
storing a plurality of storage location identifications (ID) that are assigned to a plurality of storage locations in the storage system; and
in response to identifying the storage command, assigning one of the plurality of storage location IDs to the physical object as the storage location at which the physical object is to be placed.

20. The method of claim 17, further comprising:
capturing an image of the physical object when the physical object is placed in the storage system;
storing the image of the physical object in association with the first description of the object; and
displaying the image of the physical object in response to the retrieval command.

21. The method of claim 17, further comprising:
detecting a storage time at which the physical object is placed in the storage system; and
storing the storage time in association with the first description of the physical object.

22. The method of claim 21, wherein the performing the retrieval command comprises:
performing the retrieval command in response to the second description of the physical object corresponding to the first description of the physical object, and a storage time included in the second user input matching the storage time of the physical object.

23. The method of claim 17, wherein the first user input and the second user input correspond to a first voice signal and a second voice signal, respectively, and
wherein the performing the retrieval command comprises:
performing a speaker verification process on the first voice signal and the second voice signal using a neural network to extract voice characteristics of a user; and
performing the retrieval command in response to the voice characteristics in the second user input corresponding to the voice characteristics in the first user input.

24. The method of claim 17, wherein the performing the retrieval command comprises:
performing the retrieval command by providing visual or audible information of the storage location of the physical object to the user.

25. The method of claim 24, wherein the performing the retrieval command further comprises:
displaying the storage location of the physical object in a layout image of the storage system, in response to the retrieval command.

26. The method of claim 24, wherein the performing the retrieval command further comprises:
controlling a visual indicator positioned at the storage location of the physical object to cause the visual indicator to change a color, blink, or flash, in response to the retrieval command.

27. The method of claim 17, further comprising:
in response to the second description of the physical object not corresponding to the first description of the physical object, providing an object list comprising a plurality of different object descriptions associated with corresponding storage times and object images.
